(19) United States
(12) Patent Application Publication
(10) Pub. No.: US 2013/0269253 A1
(43) Pub. Date: Oct. 17, 2013

(54) ACTUATING DEVICE FOR AN AIRCRAFT LUGGAGE LOCKER

(71) Applicant: DIEHL AIRCABIN GMBH, Laupheim (DE)

(72) Inventor: Oleg GRAF, Illertissen (DE)

(73) Assignee: Diehl Aircabin GmbH, Laupheim (DE)

(21) Appl. No.: 13/859,209

(22) Filed: Apr. 9, 2013

(30) Foreign Application Priority Data
Apr. 17, 2012 (DE) 102012007678.9

(51) Int. Cl. G08B 5/00; E05F 15/00

(52) U.S. Cl. CPC G08B 5/00; E05F 15/00
USPC 49/13; 49/506

(57) ABSTRACT

The invention relates to an actuating device for a luggage locker (1) in an aircraft that has a first operating element (5) that is arranged inside a recess (6) and is capable of transferring the luggage locker (1) from a closed state to an open state for example by way of an electromechanical drive means (7), wherein the electromechanical drive means (7) can transfer the luggage locker (1) from a closed state to an open state via a second operating element (12), wherein the first operating element (5) is coupled to an illuminated display (22) that emits electromagnetic radiation in a wavelength range visible to the human eye in order to display what state the luggage locker (1) is in.

### OBJECT OF THE INVENTION

The invention relates to an actuating device for an aircraft luggage locker.

### BACKGROUND OF THE INVENTION

Storage spaces in the form of luggage lockers, usually arranged next to one another above the rows of seats provided for the passengers, are often provided in aircraft cabins. The luggage lockers are opened relatively frequently, in particular during medium-haul and long-haul flights, in order to allow passengers to access their belongings. Because of safety regulations, the luggage lockers must, however, be closed during take-off or landing.

Luggage lockers known from the general prior art are provided with a front flap in the form of a luggage tray that enables the luggage lockers to be opened or closed by means of a suitable mechanical closing system. The luggage lockers are thus opened and closed manually, i.e. either by a passenger or by the cabin crew. In known systems, a handle needs to be pulled to open the locker. It is closed by folding up the luggage tray that needs to be pushed up until the closing system engages. The closing system is often formed by means of two locks, wherein incomplete engagement of a lock is indicated on a handle on which a plastic strip provided with a signal colour is, for example, situated.

An electronic locking system for a storage compartment of an airliner is known from US2008/078871 A1. An electronic locking system for use in a movable luggage locker is provided that is moved relative to a support structure and can be opened from a closed position. A switch is connected to the movable luggage locker and receives an input signal that effects movement of the luggage locker and a locking pin that is connected to the movable luggage locker.

The document U.S. Pat. No. 7,723,935 B2 discloses a system and a method for controlling a luggage storage locker in an airliner. A control unit is connected to a motor and monitors the operation of the motor, in particular the operating current. The control unit determines the position of the luggage storage locker in order to establish, together with the calculated required current, whether the weight of the luggage storage locker exceeds a predetermined maximum value.

The document US2008/078868 A1 describes a system having a storage compartment for commercial aircraft that has a support structure to which the storage compartment is rotatably fastened so that the storage compartment can be rotated into an opened position and a closed position. An actuating element is coupled to the rear wall of the storage compartment and is used to rotate the storage compartment between its opened and closed positions. The system thus removes the need for an individual to manually bring the storage compartment into the closed position after the storage compartment has been loaded or unloaded with luggage.

Automatically operated storage compartments are preferred to exclusively mechanical actuation for the greater comfort of passengers. However, the abovedescribed systems can only be created at relatively great expense so it would be very expensive in particular to retrofit pre-existing passenger cabins of airliners.

### DESCRIPTION OF THE INVENTION

The object of the invention is therefore to provide an alternative actuating device for a luggage locker in an aircraft, that overcomes the disadvantages mentioned at the beginning and can be employed easily in an aircraft or can be retrofitted in existing aircraft cabins.

This object is achieved by the features of Claim 1. Other advantageous embodiments of the invention are respectively the subject of the dependent claims. These can be combined with one another in a technologically sensible fashion. The description, in particular with the drawings, additionally characterizes and specifies the invention.

According to the invention, an actuating device for a luggage locker in an aircraft is provided that has a first operating element that is arranged inside a recess and is capable of transferring the luggage locker from a closed state to an open state, wherein an electromechanical drive means can transfer the luggage locker from a closed state to the open state via a second operating element, wherein the first operating element is coupled to an illuminated display that emits electromagnetic radiation in a wavelength range visible to the human eye in order to display what state the luggage locker is in.

Accordingly, the first operating element can be operated as normally, i.e. usually by being pulled, in order to open the luggage locker. The operating element then generates an electrical signal that is transmitted to the electromechanical drive means. To close the luggage locker, a second operating element is then actuated that can be positioned in such a way that it cab be seen and reached easily when the luggage tray is open. The status display can be configured such that it can be easily read so that the status of the luggage tray can be recognized easily both by passengers and the cabin crew. The invention thus makes it possible to simply equip pre-existing handles with an electronic operating function without the need to carry out any significant modifications to do so. Moreover, the use of an electromechanical drive means saves significantly more space than a solution that, for example, provides a form of mechanical power assistance when the luggage locker is opened and closed.

According to one embodiment of the invention, the illuminated display is formed by means of at least one light-emitting diode.

A light-emitting diode enables illumination with a high light output with a simultaneous low power loss so that it is advantageous for incorporation into an activating device compared with other illumination means.

According to another embodiment of the invention, the illuminated display is configured in such a way that the recess is illuminated at least partially, preferably in the form of backlighting.

As well as an optically attractive appearance, this configuration allows it to be read easily by passengers or the cabin crew.

According to another embodiment of the invention, the first operating element is arranged on a front wall of a luggage tray of the luggage locker, wherein the luggage tray, together with a corresponding shell, forms the luggage locker.

Although the invention can be used with luggage lockers having a front flap, it is particularly advantageous in this configuration to power-assist the closing using the electromechanical drive means because the loaded items of luggage are laid on the luggage tray, so that the latter must be returned into the shell against gravity.

According to another embodiment of the invention, the first operating element takes the form of a handle that can be activated by being pulled.

This type of operation is also common in the case of conventional luggage lockers so that it can be performed intuitively by both passengers and cabin crew.

According to another embodiment of the invention, the recess is designed as a recessed handle.

The illumination of the recessed handle also allows an optically attractive appearance that can be read easily by passengers or the cabin crew.

According to another embodiment of the invention, the second operating element is arranged on a front edge of a luggage tray of the luggage locker.

After opening, the front edge of the luggage tray faces the passengers or the cabin crew so that the second operating element can be reached easily.

According to another embodiment of the invention, the second operating element is designed as a push button.

A push button ensures simple and hence intuitive operability. A push button can moreover be integrated without taking up much space, which in turn facilitates retrofitting to pre-existing luggage lockers.

According to another embodiment of the invention, the electromechanical drive means is arranged between the luggage tray and the shell forming the top of the luggage locker.

Luggage lockers are normally equipped with a mechanical power-assistance function that facilitates the closing of the luggage lockers. Instead of this mechanical power-assistance function, the electromechanical drive means can be arranged between the luggage tray and the shell forming the top of the luggage locker. It is thus possible again to retrofit pre-existing luggage lockers simply and without carrying out any significant conversion work.

According to another embodiment of the invention, the electromechanical drive means is designed as an electromotor.

An electromotor can perform the required displacement function in order to enable the closing of the luggage lockers.

According to another embodiment of the invention, the illuminated display can display the open state, the closed state or a partly open state.

The illuminated display thus serves to display the status in one or more states so that it is possible to detect an unclosed or only partly closed luggage tray even at relatively great distances. Moreover, subdued backlighting of the recessed handle can, for example, also increase operability, for example during a night flight, which can provide greater comfort for the passengers.

According to another embodiment of the invention, in addition to a folded-out first operating element, the illuminated display can also indicate the partly open state.

Unlike in conventional luggage lockers where incomplete locking is indicated by the protrusion of the first operating element, according to the invention a warning function can also be performed by the illuminated display, where for example the recessed handle is illuminated with a signal colour, preferably a red, yellow or orange shade. This makes it easier, for example, to comply with safety regulations with respect to closed luggage lockers when an aircraft is taking off and landing.

Moreover, a luggage locker with an abovedescribed actuating device is provided.

Furthermore, an aircraft cabin with multiple luggage lockers is provided that is equipped at least partially with an abovedescribed actuating device.

Lastly, the invention also relates to a method for retrofitting a luggage locker in an aircraft with an abovedescribed actuating device, in which, after a handle has been removed and mechanical power assistance provided, the first operating element, the second operating element and the electromechanical drive means are installed and connected to a control unit preferably by means of a flat cable.

The method according to the invention enables pre-existing aircraft cabins to be retrofitted easily with luggage lockers that have an electronic actuating mechanism. To do this, inter alia only the handles that are often already present need to be replaced, without altering the visual appearance of the cabin.

### SHORT DESCRIPTION OF THE DRAWINGS

Some exemplary embodiments are explained in detail below with the aid of the drawings, in which:

FIG. 1 shows a lateral perspective view of an actuating device according to the invention for a luggage locker in a closed state,

FIG. 2 shows a lateral perspective view of an actuating device according to the invention for a luggage locker in an open state,

FIG. 3 shows a further lateral perspective view of an actuating device according to the invention for a luggage locker in an open state,

FIG. 4a shows a detailed view of an actuating device according to the invention,

FIG. 4b shows a further detailed view of an actuating device according to the invention, and

FIG. 4c shows a further detailed view of an actuating device according to the invention.

### DETAILED DESCRIPTION OF EXEMPLARY EMBODIMENTS

Identical components, or those which function in the same way, have been provided with the same reference numerals in the drawings.

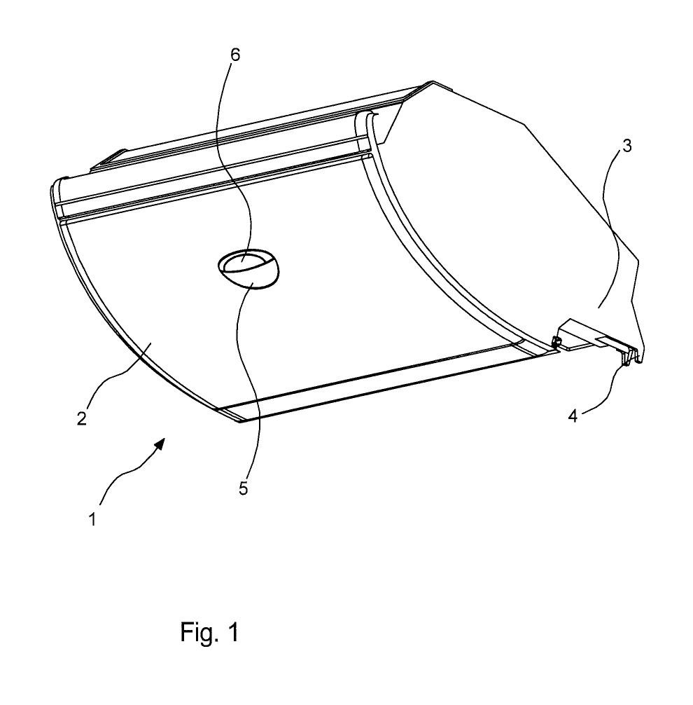

An embodiment of the invention is explained in detail below with reference to FIG. 1.

FIG. 1 shows a luggage locker 1 that has been installed, for example, above a row of seats in an aircraft. An aircraft usually has multiple such luggage lockers 1 that are arranged, for example, next to one another.

The luggage locker 1 is shown in a closed state in FIG. 1. The luggage locker 1 has a luggage tray 2 that forms the base of the luggage locker 1. The luggage tray 2 engages into a corresponding shell 3 in order to thus form the luggage locker 1. At a rear end, i.e. an end facing the cabin walls, the shell 3 has a fastening 4 for retaining the luggage locker 1 on the cabin wall (not shown in FIG. 1).

On a side facing the rows of seats (not shown in FIG. 1), the luggage tray 2 has an actuating device in the form of a first operating element 5 that is shown as a handle in FIG. 1. The first operating element 5 is arranged in a recess 6 that is shown as a recessed handle in FIG. 1.

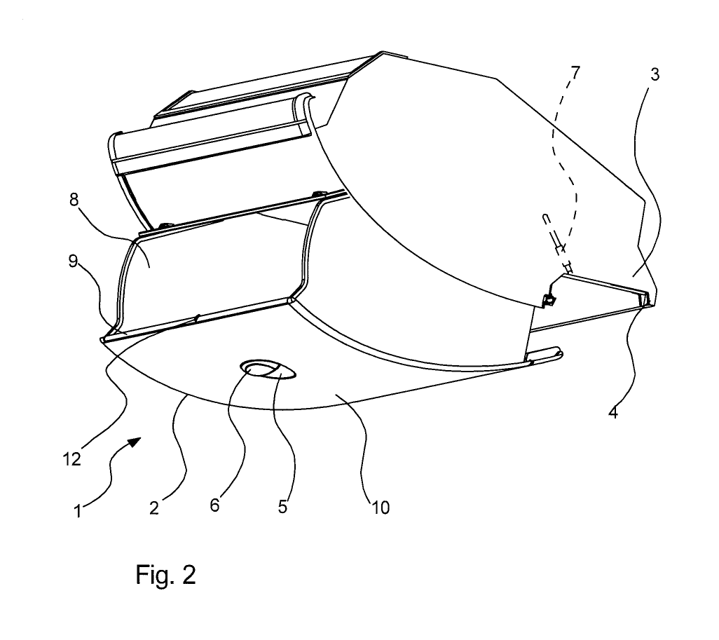

The open state of the luggage locker 1 is shown in FIG. 2. The first operating element 5 is arranged on an underside 10 of the luggage tray 2 so that it can be easily actuated by the cabin crew or passengers. An electromechanical drive means 7 is attached between the luggage tray 2 and the shell 3 in order to enable the luggage locker 1 to be opened and closed. When the first operating element or the handle 5 is pulled, the luggage tray 2 can slide downwards out of the shell 3 in order to place items of luggage or the like in the inside 8 of the luggage locker 1. When a second operating element 12 is actuated, the electromechanical drive means 7 can return the luggage tray 2 upwards into the shell 3. The second operating element 12 is designed as a push button that is arranged on a front edge 9 of the luggage tray 2.

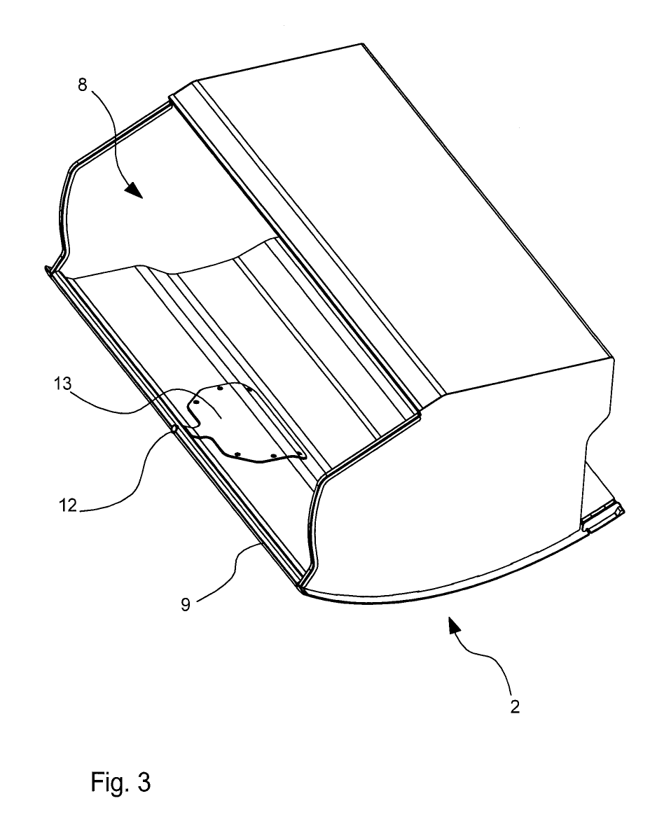

As can be seen in FIG. 3, the second operating element 12 is connected to a flat cable 13 so that signals can be sent on to a control unit that is not shown in the drawings in order to effect a corresponding actuation of the drive means 7. The flat cable 13 also covers the region of the first operating element 5 so that other signals from the first operating element 5 can also be exchanged with the control unit via the flat cable 13.

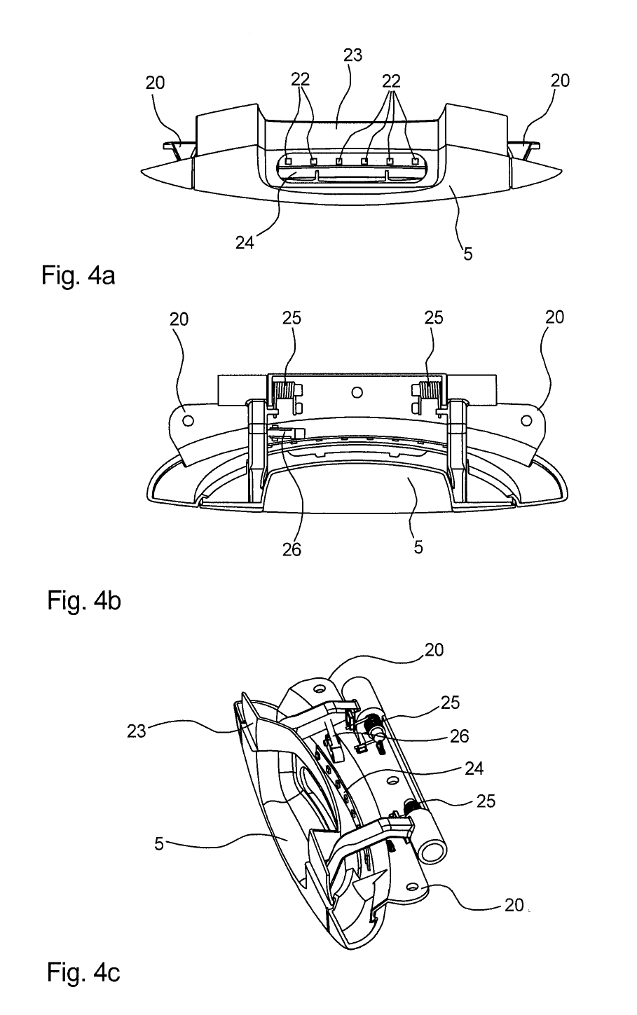

FIG. 4a shows the first operating element 5 in a view that more or less corresponds to a plane perpendicular to the underside 10. The operating element 5 has fastenings 20 to mechanically connect it to the luggage tray 2.

As shown in FIG. 4a, the first operating element 5 is coupled to an illuminated display 22 that emits electromagnetic radiation within a wavelength range visible to the human eye in order to display the state of the luggage locker 1. The illuminated display 22 can be formed by multiple light-emitting diodes. The illuminated display 22 is configured in such a way that the recess 6 is illuminated in the form of back-lighting.

The recess 6 can be illuminated, for example, via a partially transparent window 23 that is arranged inside the first operating element 5. Furthermore, as shown in FIG. 4a, the illuminated display 22 is connected to a plate 24 that serves to mechanically stabilize the light-emitting diodes as well as to transmit signals. The plate 24 can, for example, be connected to the flat cable 13 shown in FIG. 3.

FIG. 4b again shows the first operating element 5 in a different view, to be precise from a plane perpendicular to the underside 10. An isometric representation of the first operating element 5 is shown in FIG. 4c. The actuation of the first operating element 5 is detected by means of a microswitch 26 that can likewise be connected to the control unit via the flat cable 13. The handle is closed via the restoring elements 25 that are shown as springs in FIG. 4b and FIG. 4c.

As already mentioned, the illuminated display 22 can display the open state, the closed state or a partly open state of the luggage tray 2.

It is, moreover, provided that the illuminated display can display the partly open state of the luggage tray 2 in addition to a folded-out first operating element 5.

The incomplete locking of the luggage tray 2 is then indicated, on the one hand, by the projection of the first operating element 5. On the other hand, an additional warning function is effected by the illuminated display 22 by, for example, the recessed handle 6 being illuminated with a signal colour, i.e. with a red, yellow or orange shade. This makes it possible, for example, to comply with corresponding safety regulations for closed luggage lockers 1 when an aircraft is taking off and landing.

Existing handles of luggage lockers 1 can be easily retrofitted in an aircraft. To do this, after the existing handle has been removed and mechanical power assistance provided, the first operating element 5, the second operating element 12 and the electromechanical drive means 7 are installed and then connected to a control unit by means of a flat cable 13.

### LIST OF REFERENCE NUMERALS

1 luggage locker
2 luggage tray
3 shell
4 retainer
5 first operating element
6 recess
7 electromechanical drive means
8 opening
9 front edge
10 underside
11 rear wall
12 second operating element
13 flat cable
20 fastening means
22 illuminated display
23 partly transparent window
24 plate
25 restoring means
26 microswitch

1. An actuating device for a luggage locker in an aircraft that has a first operating element that is arranged inside a recess and is capable of transferring the luggage locker from a closed state to an open state, wherein an electromechanical drive means can transfer the luggage locker from a closed state to an open state via a second operating element, wherein the first operating element is coupled to an illuminated display that emits electromagnetic radiation in a wavelength range visible to the human eye in order to display what state the luggage locker is in.

2. The actuating device according to claim 1, wherein the illuminated display is formed by means of at least one light-emitting diode.

3. The actuating device according to claim 1, wherein the illuminated display is configured in such a way that the recess is at least partially illuminated.

4. The actuating device according to claim 3, wherein the illuminated display is illuminated in the form of backlighting.

5. The actuating device according to claim 1, wherein the first operating element is arranged on an underside of a luggage tray of the luggage locker, wherein the luggage tray, together with a corresponding shell, forms the luggage locker.

6. The actuating device according to claim 5, wherein the first operating element takes the form of a handle that can be activated by being pulled.

7. The actuating device according to claim 6, wherein the recess is designed as a recessed handle.

8. The actuating device according to claim 1, wherein the second operating element is arranged on a front edge of a luggage tray of the luggage locker.

9. The actuating device according to claim 8, wherein the second operating element is designed as a push button.

10. The actuating device according to claim 1, wherein the electromechanical drive means is arranged between the luggage tray and the shell forming the top of the luggage locker.

11. The actuating device according to claim 10, wherein the electromechanical drive means is designed as an electromotor.

12. The actuating device according to claim 1, wherein the illuminated display can display the open state, the closed state or a partly open state.

13. The actuating device according to claim 12, wherein, in addition to a folded-out first operating element, the illuminated display can also indicate the partly open state.

14. A luggage locker comprising the actuating device according to claim 1.

15. An aircraft cabin with multiple luggage lockers that is equipped at least partially with the actuating device according to claim 1.

16. A method for retrofitting a luggage locker in an aircraft with the actuating device according to claim 1, in which, after a handle has been removed and mechanical power assistance provided, the first operating element, the second operating element and the electromechanical drive means are installed and connected to a control unit preferably by means of a flat cable.

17. The method according to claim 16, wherein the first operating element, the second operating element and the electrochemical drive means are connected to the control unit by means of a flat cable.
